(19) United States
(12) Patent Application Publication
(10) Pub. No.: US 2008/0100169 A1
(43) Pub. Date: May 1, 2008

(54) HOMOPOLAR ELECTRICAL GENERATOR

(76) Inventor: Hai Tee Young, El Monte, CA (US)

Correspondence Address: Lin Yu, 11597 Tree Hollow Lane, San Diego, CA, 92128, US

(21) Appl. No.: 11/555,223

(22) Filed: Oct. 31, 2006

(51) Int. Cl. H02K 31/00

(52) U.S. Cl. 310/178; 310/268

(57) ABSTRACT

The present invention relates to a homopolar generator which comprises a plurality of stationary electrically conductive plates, a plurality of rotary magnetic plates, a drive device for effecting the rotation of the rotary magnetic plates, and an electrical circuit assembly for extracting electrical current from the generator.

### TECHNICAL FIELD

The present invention relates to an electrical generator, in particular to a direct-current homopolar generator.

### BACKGROUND OF THE INVENTION

As the demand for energy has increased and the supplies of fossil dwindled, there have been increasing interests in developing an efficient electrical generator to fully utilize green power resources such as wind energy and to efficiently recover otherwise wasted mechanical energy from a moving vesicle and to transform them into storable electrical energy. Due to its simplicity in design, the Faraday disk generator, the very first electrical generator, has been proved to be a valuable model, upon which a more efficient and advanced generator can be built.

The classical Faraday disk generator comprises a circular conductive disk which rotates about its axis in the presence of an axial magnetic field. Electrical contacts contact the disk at various radial positions on the disk, such as the center of the disk and the outer periphery of the disk, extracting current resulting from the voltage induced between the inner and outer peripheries of the disk when rotational energy was supplied by an external driving force. Since the magnetic field through which the conductive disk rotates is oriented in one direction and the distance between the inner and outer peripheries is typical very short, the Faraday disk generator produces a constant direct current inherently having a high amperage and low voltage. This significantly limits its practical applications. Due to its unidirectional configuration, the Faraday disk generator is sometimes also known as a unipolar or homopolar generator.

A number of permutations of this very first homopolar generator have been developed since. Examples of homopolar generators wherein a conductive disk rotates in a stationary magnetic field are disclosed in U.S. Pat. Nos. 3,465,187; 3,882,366; 4,097,758; 4,208,600; and 5,451,825. In addition to low voltage current, these generators also tend to be bulky and have low efficiencies. It would therefore be especially advantageous to provide a compact, lightweight, and efficient generator that is also capable of generating high voltage electricity and is suitable for a vast variety of personal and commercial applications.

### SUMMARY OF THE INVENTION

The present invention provides a homopolar generator, which comprises a plurality of stationary electrically conductive plates, a plurality of rotary magnetic plates, a drive assembly for effecting the rotation of the rotary magnetic plates, and an electrical circuit assembly for extracting electrical current from the stationary conductive plates. The conductive plates and magnetic plates are configured as such that every conductive plate is sandwiched between two rotary magnetic plates, thus forming a homopolar generator unit. As such, the number of magnetic plates is one greater than the number of the conductive plates. Additionally, the magnetic plates are all mounted with their magnetic polarity aligned in the same direction to generate a magnetic flux substantially perpendicularly to the surfaces of each electrically conductive plate.

The conductive plate in the homopolar generator of the present invention is an annular disk with an inner and outer periphery. These two peripheries may both be electrically conductive and thus the outer periphery functions as a first electrical terminal and the inner periphery functions as a second electrical terminal that is opposite to the first terminal. The conductive plate comprises two or more radial dielectric dividers each with an inner and outer end, partitioning the annular disk, substantially evenly, into the same number of radial segments. Some of the dielectric dividers also have a mounting bore adjacent to its inner end, through which the conductive plate is assembled together coaxially with the other magnetic and conductive plates as a generator core. The conductive plate also has a central opening, once assembled, forming a conduit with the other conductive and magnetic plates for routing stationary electrical wires that are connected to the inner peripheries of the conductive plates.

In one embodiment, the radial segments each are an electrically conductive radial plate with an inner and outer end. The inner end is connected to the inner periphery, whereas the outer end is connected to the outer periphery of the conductive plate.

In an alternative embodiment, the radial segments each are an inducible assembly, which comprises a plurality of electrically wires each having an inner and outer terminal. The wires are aligned radially on the conductive plate, with their outer terminals interconnected electrically to the outer periphery as a first electrical terminal of the inducible assembly and their inner terminals interconnected electrically to the inner periphery of the conductive plate as a second electrical terminal of the inducible assembly. The first electrical terminal is engaged with an electrical contact on the electrical circuit for current extraction.

The rotary magnetic plate in the homopolar generator of the present invention is an annular disk comprising an outer annular segment of a permanent magnet and an inner annular segment, which has a rotary bearing to allow the outer magnetic segment freely rotate around the inner segment. The inner segment also contains two or more mounting bores, through which the magnetic plate is assembled together coaxially with the other magnetic and conductive plates. The rotary magnetic plate also has a plurality of mounting bores on its outer periphery for attaching the electrical circuit assembly and/or the drive assembly to the generator. Furthermore, the magnetic plate also has a central opening, once assembled, forming a conduit with the other conductive and magnetic plates for routing stationary electrical wires.

The drive assembly in the homopolar generator of the present invention comprises one or more drive devices, each containing one or more mounting devices for the attachment to the rotary magnetic plates. In one aspect of the present invention, the drive assembly has two or more wind blades as the drive devices for capturing and transforming wind energy into storable electrical energy. The wind blades may configured in various sizes to suit a particular commercial or personal application. For example, the wind blades are dimensioned as such that the homopolar generator is suitable for powering a family housing unit, such as an apartment in a multi-family housing complex or a single family house. In another aspect of the present invention, the drive device is a component of an indirectly driven relay system, such as a gear, a belt, a chain and the like. This is especially suitable for capturing and converting rotational energy into storable electrical energy. The drive devices may directly be attached to the homopolar generator via the mounting bores on the outer peripheries of the rotary magnetic plates.

In an alternative embodiment, the drive assembly further comprising a cylindrical housing to protect the homopolar generator from rains and dusts. The cylindrical housing comprises a rotary cylinder with a side wall, a bottom opening, and a plurality of mounting bores on the side wall, through which the rotary cylinder is connected to the rotary magnetic plates directly or via the mounting devices of the drive devices. Once assembled, the cylinder rotates together with the magnetic plates and the drive devices. The cylindrical housing further comprises a stationary circular plate with an opening for electrical wires. The drive devices may be attached to the mounting bores on the outer peripheries of the rotary magnetic plates via the mounting bores of the cylinder. Alternatively, the drive elements may be attached to the rotary magnetic plates indirectly. As such, the drive devices each are first mounted to the sidewall of the rotary cylinder at the positions that are different from the mounting bores on the side wall, and then the rotary cylinder is then mounted to the rotary magnetic plates via the mounting bores of the rotary cylinder.

The electrical circuit assembly in the homopolar generator of the present invention comprises a plurality of electrical transfer devices, each comprising an electrical wire with a first and second electrical terminal, wherein the first terminal is attached thereto a first electrical contact and the second terminal is attached thereto a second electrical contact. The electrical circuit assembly further comprises a stationary plate having a plurality of annular conductive segments, each separated from the other via a dielectric annular divider. The number of the electrical transfer devices is the same as the number of the homopolar generator units in the homopolar generator. The number of the annular conductive segments is also the same as that of the homopolar generator units. To extract electrical current from the homopolar generator, the first electrical contact of an electrical transfer device is engaged in physical contact with a conductive plate of a generator unit whereas the second electrical contact is engaged in physical contact with an annular conductive segment on the stationary plate. As such, these generator units in the homopolar generator can be configured parallel for maximizing the amperage or serially for maximizing the voltage of the current output.

### BRIEF DESCRIPTION OF THE DRAWINGS

FIG. 1 is a partially exposed perspective view of a wind-powered homopolar generator according to one embodiment of the present invention.

FIG. 2 is a perspective view of the core of a homopolar generator containing four generator units.

FIG. 3 are perspective (A) and top (B) views of a stationary conductive plate comprising a plurality of radial sections.

FIG. 4 are perspective (A) and top (B) views of a rotary magnetic plate with an outer magnetic segment having mounting bores around its outer periphery and an inner segment which contains a rotary bearing coaxial with the magnetic plate.

FIG. 5 is a cross-sectional view along line A-A′ of FIG. 1.

FIG. 6 is a partially exploded view of a wind-powered drive assembly.

FIG. 7 is a perspective view of a drive assembly with a gear as its drive device.

FIG. 8 are a perspective views of the electrical circuit assembly: A. an electrical transfer device having an electrical wire with a first terminal attached to a first electrical contact and a second terminal attached to a second electrical contact; and B. an exploded view of the electrical assembly according to one embodiment of the present invention.

FIG. 9 is a perspective view of a wind-propelled driven homopolar generator for capturing and converting wind energy into storable electrical energy according to one exemplary embodiment of the present invention.

### DETAILED DESCRIPTION OF THE INVENTION

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

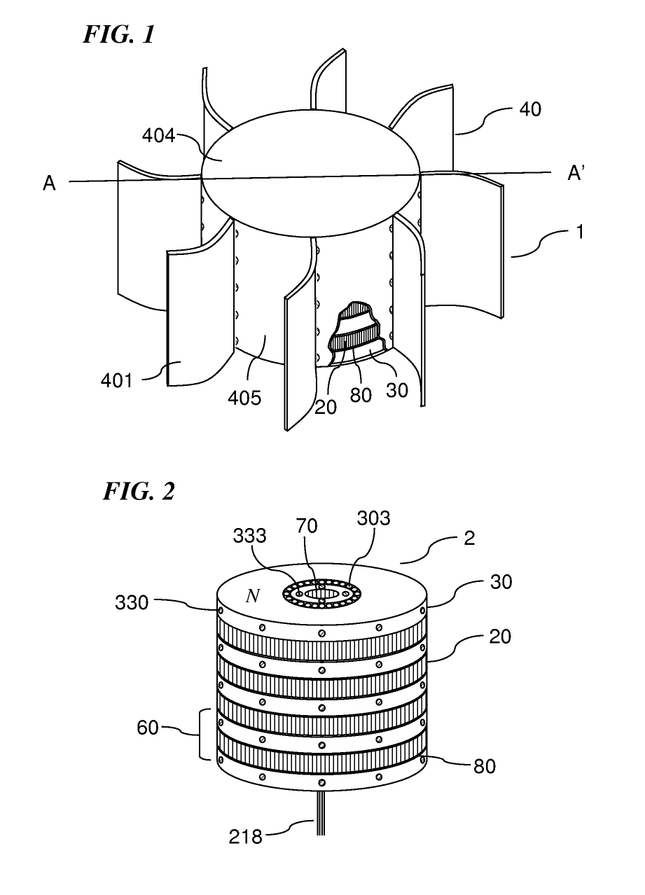

The homopolar electrical generator 1 as shown in FIGS. 1 and 2 comprises a plurality of stationary electrically conductive plates 20, a plurality of rotary magnetic plates 30, a drive assembly 40, and an electrical circuit assembly 50 for current extraction. The stationary conductive plates 20 and the rotary magnetic plates 30 together form the core 2 of the homopolar generator 1 (FIG. 2). The conductive plates 20 and magnetic plates 30 are configured as such that every conductive plate 20 is sandwiched between two rotary magnetic plates 30 as a homopolar generator unit 60. Consequently, the generator core 2 contains magnetic plates 30 that is one greater than the conductive plates 20.

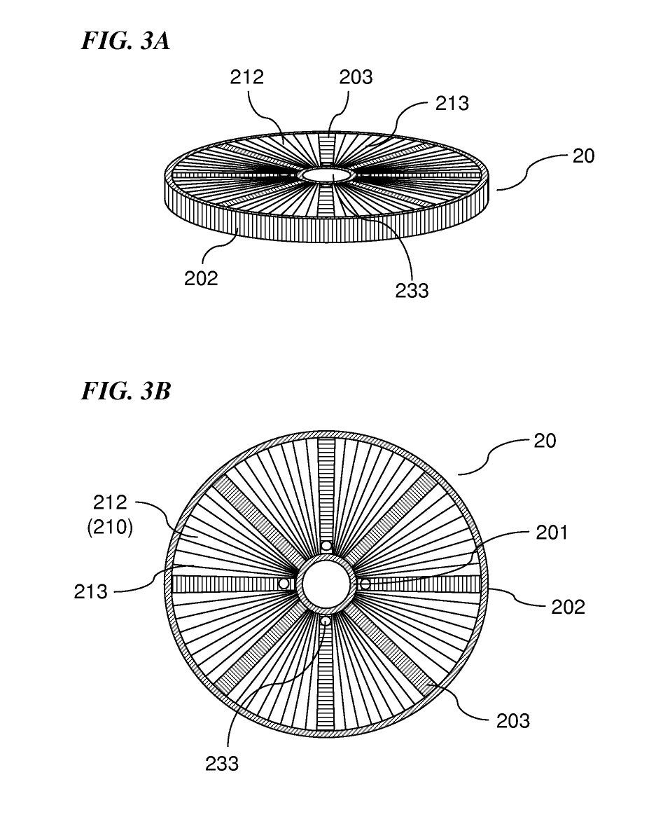

The conductive plates 20 as shown in FIG. 3 each have an inner and outer periphery (201 and 202), and two or more radial dielectric dividers 203, which partition the conductive plate 20 into the same number of radial segments 210. The outer periphery 202 is constructed from an electrically conductive material and engaged in physical contact with an electrical contact 511 on the electrical circuit assembly 50 for current extraction as described herein below. The stationary conductive plate 20 may have various shapes, including, but not limited to, disk, cylinder, square, rectangle, and polygons, such as pentagon, hexagon, heptagon, and octagon. A disk-shaped conductive plate 20 is illustrated in FIG. 3.

The radial segment 210 may be an electrically conductive plate 211 or inducible assembly 212, which comprises a plurality of electrically wires 213 each having an inner terminal 214 and outer terminal 215. The electrical wires 213 of the inducible assembly 212 are each aligned radially with the outer terminal 215 electrically interconnected to the outer conductive periphery 202 as a first electrical terminal 217 for the inducible assembly 212 and the inner terminal 214 attached to the inner periphery 201. The inner terminals 214 of the electrical wires 213 in the same inducible assembly 212 may also be electrically interconnected as a second electrical terminal 216 for the radial inducible assembly 212. The second terminal 216 may further be connected via a stationary electrical wire 218 as an extension to connect with an electricity storage device such as a battery or electrically powered device for operation. The conductive plate 20 also has a central opening 219, once assembled, forming a conduit 70 with the other plates (20 and 30) for the stationary electrical wires 218.

Suitable electrically conductive materials for the plate 211 or wires 213, the conductive outer periphery 202, the electrical circuit assembly 50, and other electrical conductive parts used in the present invention include, but are not limited to, conductive metals and alloys, such as copper, aluminum, silver, gold, and platinum, and electrically conductive composite materials or polymers.

The dielectric divider 203 has an inner end 231 mounted adjacent to the inner periphery 201 and an outer end 232 mounted adjacent to the outer periphery 202. The dielectric divider 203 may also have a mounting bore 233 adjacent to its inner end 231, through which the conductive plate 20 is assembled together coaxially with the other plates (20 and 30). The dielectric divider 203 may be made from a variety of commercially available dielectric materials, which may be well known to the person in the art. The conductive plate 20 may have two or more, three or more, four or more, six or more, eight more, ten or more, twelve or more, sixteen or more, twenty or more, twenty-four or more, thirty-two or more, or sixty-four or more dielectric dividers 203, thus dividing the conductive plate 20 into the same number of radial segments. The radial dielectric dividers 203 are substantially evenly distributed on the conductive plate 20 so that all the radial segments 210 are substantially the same in dimensions.

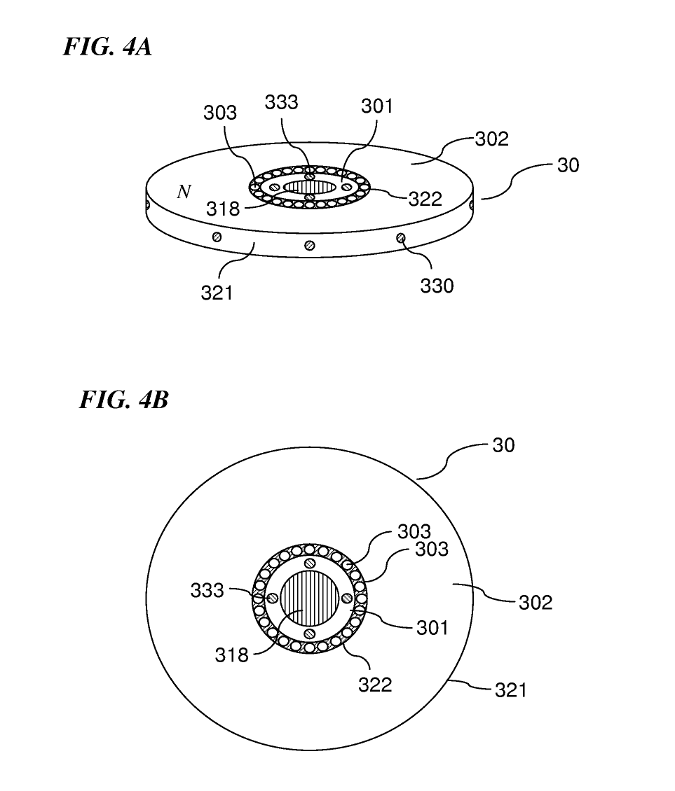

The rotary magnetic plate 30 as shown in FIG. 4 comprises an inner annular segment 301 and an outer annular segment 302 with an outer periphery 321 and inner periphery 322. The inner periphery 321 of the out segment 302 is in direct contact with the inner segment 301. The inner segment 301 has a rotary bearing 303, coaxial with the magnetic plate 30 to allow the plate 30 freely rotate around its axis. The inner segment 301 also has two or more mounting bores 333 through which the magnetic plate 30 is assembled together coaxially with the other magnetic and conductive plates (20 and 30). Typically, the inner segment 301 may have a central opening 318, once assembled, forming a conduit 70 with the other magnetic and conductive plates (20 and 30) for the stationary electrical wires 218. Optionally, one of the two outside magnetic plates 30, the first and last magnetic plates 30, in the assembled homopolar generator 1, does not have a central opening 318 in its inner segment 301. The inner segment 301 may be constructed from a non-ferromagnetic material, such as stainless steel.

The outer segment 302 is a permanent magnet with one magnetic polarity on the top surface and the opposite magnetic polarity on the opposite bottom surface of the magnetic plate 30. The outer segment 302 of the magnetic plate 30 may be constructed from a variety of commonly used magnetic materials, including, but not limited to, neodymium iron and boron (Nd—Fe—B) or samarium cobalt (SmCo). The rotary magnetic plate 30 also has a plurality of mounting bores 330 on its outer periphery 321 for attaching the electrical circuit assembly 50 and/or the drive assembly 40 to the generator 1 via a series of the magnetic plates 30.

The magnetic plate 30 may have various shapes, including, but are not limited to, disk, cylinder, square, rectangle, and polygons, such as pentagon, hexagon, heptagon, and octagon. A disk-shaped magnetic plate 30 is exemplified in FIG. 4. In certain embodiments of the present invention, the magnetic plate 30 is dimensioned substantially similar to the electrically conductive plate 20. The thickness of the magnetic plate 30 may be varied to suit a particular application. In general, the thickness of the magnets is determined by balancing the factors such as the amount of electricity to be produced versus the overall size and/or weight of the assembled homopolar generator 1.

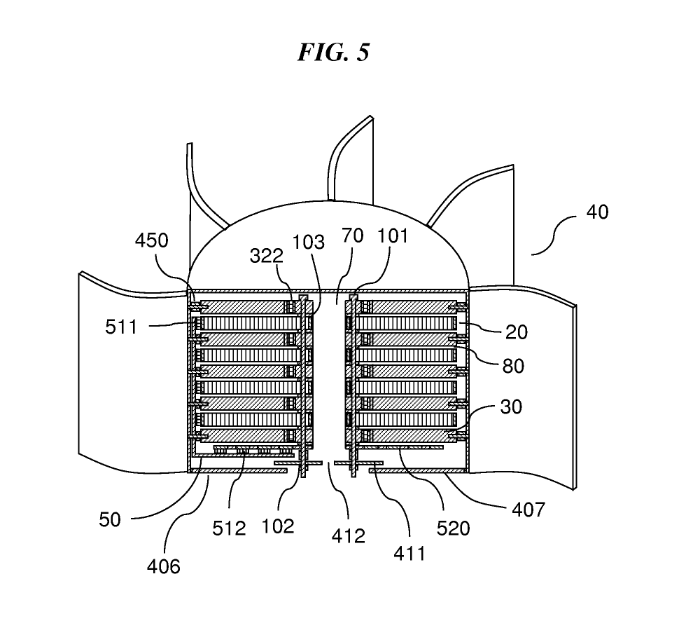

The homopolar generator 1 of the present invention may comprise two or more generator units 60. To maximize the efficiency and decrease the weight of the generator 1, the number of the magnetic plates 30 is configured to be one greater than the number of the stationary conductive plates 20. The homopolar generator 1 further comprises two or more mounting devices 100 for assembling the stationary conductive plates 20 and rotary magnetic plates 30 together through their mounting bores 233 and 333. The mounting devices 100 may also be used to attach the homopolar generator 1 to other structures, such as buildings or vesicles. Suitable mounting devices 100 include, but are not limited to, bolts 101 and nuts 102 (FIG. 5). As discussed herein above, the conductive plates 20 and magnetic plates 30 are mounted in such configuration that every conductive plate 20 is sandwiched between two rotary magnetic plates 30. In addition, all magnetic plates 30 are configured with all the magnetic polarities aligned in the same direction, thus producing an axial magnetic flux which is substantially perpendicular to the surfaces of the stationary conductive plates 20. In such configuration, the magnetic plates 30 resided in the middle of the homopolar generator 1 each serve as magnetic poles for two adjacent generator units 60.

To increase the electricity-generating efficiency and to prevent overheating, the homopolar generator 1 may comprise an air gap 80 between a magnetic plate 30 and its adjacent conductive plates 20 to reduce friction and to increase air circulation. The air gap 80 may be created by adding a gasket 103 between the stationary inner segment 301 of a magnetic plate 30 and a stationary conductive plate 20. Optionally, the homopolar generator 1 may also comprise a toroid 90 between a magnetic plate 30 and a conductive plate 20 to increase the magnetic flux. The toroids 90 may each have a similar dimension to the magnetic plate 30 and are constructed from a high magnetic permeable material.

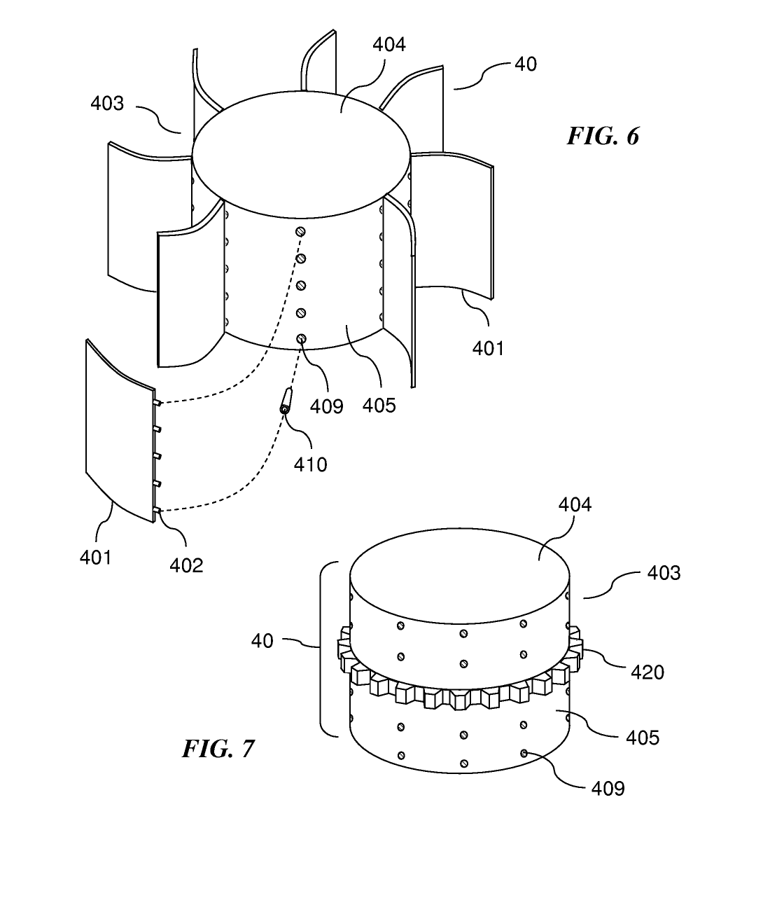

The homopolar generator 1 of the present invention may be driven by various forms of energy, including, but not limited to, wind energy, hydraulic energy, and mechanical energy. In one embodiment, the drive assembly 40 comprises one or more drive devices 401 each having a plurality of mounting devices 402 (FIG. 6). The drive devices 401 may be attached to the rotary magnetic plates 30 directly via the mounting bores 330 on the peripheries 321 of the magnetic plates 30.

In an alternative embodiment, the drive assembly 40 further comprises a cylindrical housing 403 with a rotary cylinder 404 with a sidewall 405 and a bottom opening 406 to allow the generator core 2 in during assembling, a bottom wall 407 with an opening 408, and a plurality of mounting bores 409 on the sidewall 405, through which the rotary cylinder 404 is connected to the rotary magnetic plates 30 via the mounting bores 330 on the peripheries 321 of the magnetic plates 30. The cylindrical housing 403 serves as an enclosure to protect the core 2 of the homopolar generator 1 from rain and dust damages. To ensure the cylindrical housing 403 is completely sealed off from rains and dusts, the cylindrical housing 303 also includes a plurality of washers 410 to tightly seal the mounting bores once assembled (FIG. 6). Once assembled, the cylinder 404 and the bottom wall 407 rotate together with the magnetic plates 30 and the drive devices 401. In addition, the cylindrical housing 403 may also comprise a stationary circular plate 411 having two or more mounting bore 413 for attaching to the generator core 2 and an opening 412 for the electrical wires 218 from the stationary conductive plates 30 and the electrical circuit assembly 50. The opening 412 on the stationary plate 411 is significantly smaller than the conduit 70 to provide further protection for the generator core 2.

The drive devices 401 may be attached to the mounting bores 330 on the outer peripheries 321 of the rotary magnetic plates 30 via the mounting bores 409 of the cylinder 404 with the washers 410. Alternatively, the drive devices 401 may be mounted to the side wall 405 of the rotary cylinder 404 at the positions that are different from the mounting bores 409 and then to the magnetic plates 30 via the mounting bores 409 on the cylinder 404 with the washers 410. The cylindrical housing 403 may further comprise a plurality of washers 450 between the outer peripheries 321 of the magnetic plates 30 and the inner wall of the rotary cylinder 404, providing a space between the inner wall of the cylinder 404 and the outer peripheries of the conductive plates 20 to avoid frictional contact between these components.

In one exemplary embodiment depicted in FIG. 6, the drive devices 401 each are a wind blade 420 for capturing and converting wind energy into storable electrical energy. In general, the drive assembly 40 includes two or more wind blades 420, which are dimensioned as such that the homopolar generator 1 is suitable for powering a family housing unit, such as an apartment in a multi-family housing complex or a single family house.

In another exemplary embodiment depicted in FIG. 7, the drive assembly 40 has one drive device 401, which is a gear, chain or belt, a component of an indirectly driven relay assembly 430. This is especially suitable for capturing and converting rotational energy into storable electrical energy. For example, the homopolar generator 1 with a gear drive assembly 40 may be used for the recovery of otherwise wasted mechanical energy from a moving vesicle during braking.

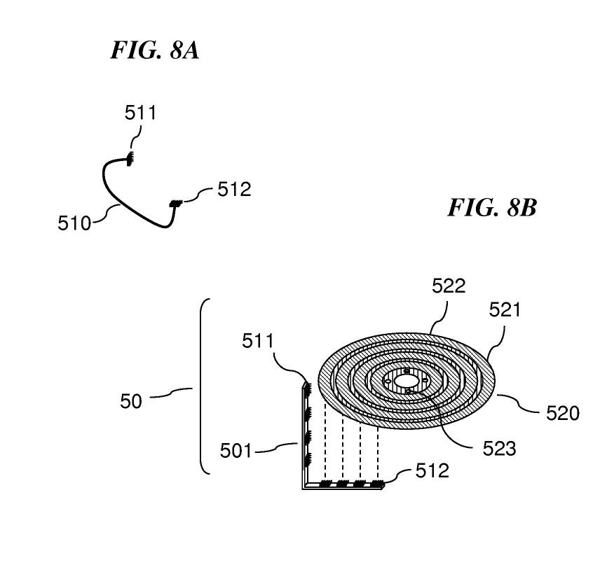

The electrical circuit assembly 50 as shown in FIG. 8 comprises an electrical transfer assembly 501 comprising a plurality of electrical transfer devices 502, each having an electrical wire 510 with a first electrical contact 511 on its first terminal and a second electrical contact 512 on its distal second terminal. The electrical contacts 511 and 512 are sliding contacts such as conductive brushes. The electrical circuit 50 assembly also comprises a stationary plate 520 having a plurality of annular conductive segments 521 and a plurality of annular dielectric dividers 522, where the conductive segments 521 are each separated from the other by the annular dielectric divider 522. The stationary plate 520 also has two or more mounting bores 523 for attaching to the generator core 2. The number of the electrical transfer devices 502 is the same as the number of the generator units 60 in the homopolar generator 1. The number of the annular conductive segments 521 is no greater than the number of the generator units 60. To maximize the voltage of the output current generated from the homopolar generator 1, the number of the annular conductive segments 521 is the same as that of the generator units 60. To extract current from the homopolar generator 1, the first electrical contact 511 of the electrical transfer device 502 is engaged in physical contact with the outer periphery 202 of the conductive plate 20 of a generator unit 60 whereas the second electrical contact 512 is engaged in physical contact with an annular conductive segment 521 on the stationary plate 520. Depending on the application, these generator units 60 in the homopolar generator 1 may be configured in parallel to maximize the amperage or serially to maximize the voltage of the output current. If desired, the homopolar generator 1 may also comprise a converter that is able to convert a high amperage current to a high voltage current.

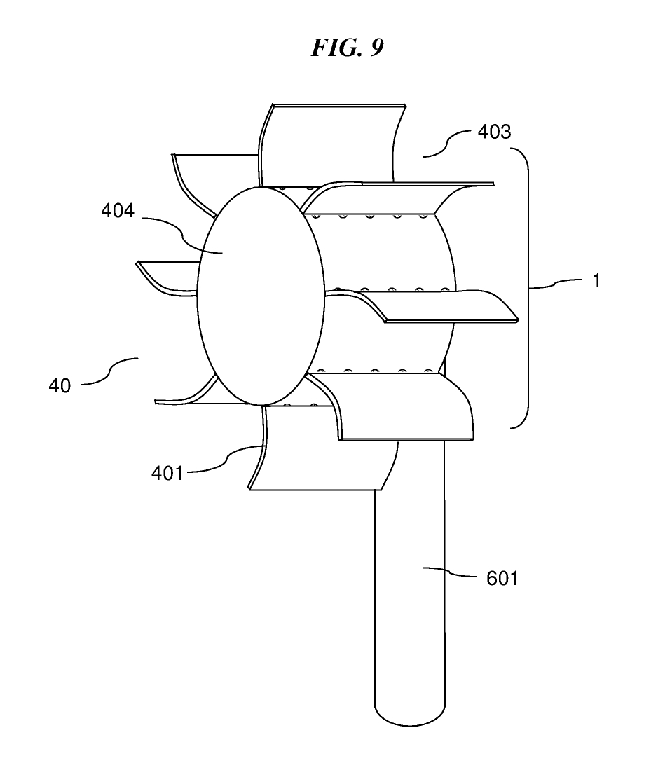

The design of the homopolar generator 1 of the present invention is flexible and versatile. The dimensions of the homopolar generator 1 may readily be adapted to different dimensions to suit to a specific application. The dimension and the weight of the homopolar generator 1, for example, can be changed by varying the diameter or thickness of the magnetic plates 30, or the number of generator units 60. The homopolar generator 1 of the present invention may contain 2 or more, 3 or more, 4 or more, 5 or more, 10 or more, 20 or more, 50 or more homopolar generator units 60. FIG. 9 shows a wind-power homopolar generator 1 attached to a supporting pole 601. Two or more homopolar generators 1 may be assembled together in a single pole. One or more wind powered homopolar generator 1 may also be used in a moving vesicle (e.g., a car, truck, train, ship, or airplane).

In operation, the rotary magnetic plates 30 are driven by a rotational energy to rotate around the coaxial stationary conductive plates 20. As the magnetic plates 30 rotate, the radial segments 210 on the conductive plates 20 cut the axial magnetic flux formed by these magnetic plates 30, which is substantially perpendicular to the conductive plates 20, and thus create an induced emf and a corresponding radial current in the radial segments 210. The direction of the current can be easily altered by controlling the rotation direction of the magnetic plates 30, clockwise or counter clockwise. The current is then withdrawn from the generator 1 through the stationary wires 218 and the electrical circuit assembly 50. The stationary wires 218 are routed through the inner conduit 70 in a center of a series of coaxial magnetic and conductive plates (20 and 30). Since the induced current produced by the generator 1 of the present invention is always in the same direction, it simplifies the production processes and eliminates the need for commutation or rectification in order to obtain DC current.

The examples set forth above are provided to give those of ordinary skill in the art with a complete disclosure and description of how to make and use the preferred embodiments of the systems and devices, and are not intended to limit the scope of what the inventors regard as their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to the incorporated herein by reference.

What is claimed is:

1. A homopolar generator comprising:
a plurality of stationary electrically conductive plates each with an inner and outer periphery;
a plurality of rotary permanent magnetic plates;
a drive assembly for effecting the rotation of the rotary magnetic plates; and
an electrical circuit assembly;
wherein the number of the magnetic plates is one greater than the number of the electrically conductive plates, and the magnetic plates and electrically conductive plates are mounted coaxially as such that every conductive plate is sandwiched between two magnetic plates, the magnetic plates are all mounted with their magnetic polarity aligned in the same direction to generate a magnetic flux substantially perpendicularly to the surfaces of each electrically conductive plate.

2. The homopolar generator of claim 1, wherein the stationary conductive plate comprises two or more dielectric dividers each with an inner end and outer end, the dielectric dividers are each aligned radially with the inner end mounted to the inner periphery and the outer end mounted to the outer periphery of the conductive plate, thus partitioning the conductive plate into two or more axial inducible segments.

3. The homopolar generator of claim 2, wherein the dielectric divider comprises a mounting bore adjacent to the inner end;

4. The homopolar generator of claim 1, wherein the outer periphery is electrically conductive.

5. The homopolar generator of claim 4, wherein the inducible segment is an inducible assembly which comprises a plurality of electrically wires each with an inner and outer terminal, the wires aligned radially in the inducible assembly with their outer terminals interconnected electrically to the conductive outer periphery and their inner terminals attached to the inner periphery.

6. The homopolar generator of claim 5, wherein the inner terminals of the wires are electrically interconnected.

7. The homopolar generator of claim 5, wherein the inner periphery is electrically conductive and the inner terminals of the wires are electrically interconnected to the inner periphery.

8. The homopolar generator of claim 1, wherein the magnetic plate further comprises an inner annular segment and outer magnetic segment having an outer and inner periphery.

9. The homopolar generator of claim 8, wherein the inner annular segment further comprises a rotary bearing coaxial with the magnetic plate.

10. The homopolar generator of claim 8, wherein the inner annular segment further comprises two or more mounting bores.

11. The homopolar generator of claim 8, wherein the outer annular segment is a permanent magnet.

12. The homopolar generator of claim 8, wherein the outer annular segment comprises a plurality of mounting elements for attaching the drive assembly or the electrical circuit assembly.

13. The homopolar generator of claim 1, wherein the drive assembly further comprises two or more wind blades.

14. The homopolar generator of claim 1, wherein the drive assembly comprises a component of a relay system.

15. The homopolar generator of claim 1, wherein the drive assembly further comprises a cylindrical housing for the protection of the homopolar generator.

16. The homopolar generator of claim 1, wherein the electrical circuit assembly comprises a plurality of electrical transfer devices and a stationary plate.

17. The homopolar generator of claim 16, wherein the stationary plate comprises a plurality of annular conductive segments and a plurality of dielectric annular divider, wherein the annular conductive segments each are separated by the dielectric annular divider.

18. The homopolar generator of claim 16, wherein the electrical transfer device comprises an electrical wire with a first and second terminal, a first electrical contact attached to the first terminal, and a second electrical contact attached to the second terminal.

19. The homopolar generator of claim 1 further comprising a converter to generate a high-voltage current.
